(19) United States
(12) Patent Application Publication
(10) Pub. No.: US 2005/0139452 A1
(43) Pub. Date: Jun. 30, 2005

(54) Multifunctional conveying drum

(75) Inventors: Manfred Folger, Hamburg (DE); Dierk Wedekind, Grossschretstaken (DE); Sonke Horn, Geesthacht (DE)

Correspondence Address: VENABLE LLP, P.O. BOX 34385, WASHINGTON, DC, 20435-9998, US

(73) Assignee: Hauni Maschinenbau AG, Hamburg (DE)

(21) Appl. No.: 10/968,090

(22) Filed: Oct. 20, 2004

(30) Foreign Application Priority Data
Oct. 24, 2003 (DE) 103 49 967.9

(51) Int. Cl. B65G 47/34

(52) U.S. Cl. 198/468.4

(57) ABSTRACT

The invention relates to a conveying drum for articles in the tobacco-processing industry. The conveying drum includes displacement means for moving articles, that are aligned in a longitudinal axial direction relative to each other and are supplied cross-axially in at least one row to the conveying drum, wherein the displacement means includes an electric drive. The invention furthermore relates to the use of an electric drive in a conveying drum, as well as to a machine in the tobacco-processing industry.

### CROSS-REFERENCE TO RELATED APPLICATION

This application claims the priority of German Patent Application No. 103 49 967.9, filed on Oct. 24, 2003, the subject matter of which is incorporated herein by reference.

The invention relates to a drum for conveying articles in the tobacco-processing industry, including a displacement means for articles that are aligned coaxially relative to each other and are conveyed cross-axially in at least one row to the conveying drum. The invention furthermore relates to the use of an electric drive in a conveying drum, as well as a machine in the tobacco-processing industry.

Generally, articles in the tobacco-processing industry are understood to be rod-shaped objects that are held by a vacuum in one or several parallel sequences on devices for conveying the articles, for example the conveying drums of filter or cigarette makers. Articles of this type are filter cigarettes, cigars, cigarillos as well as filter rods, filter members and the like. Any references in the following to cigarettes or filters only are made for reasons of simplicity and apply equally to other articles for conveying of the aforementioned type, for example filter members.

Cigarettes are held in place with the aid of a vacuum and are positioned crosswise to their longitudinal axial orientation on conveying drums, which for the most part are the drums of cigarette makers and or filter-tipping machines. Two essentially parallel rows of cigarettes may be arranged side-by-side on the conveying drums and may be moved on these drums at a right angle relative to the cigarette axes. For example, a double-length filter may be inserted between two coaxially aligned cigarettes. In this situation, double-length tobacco rods are cut in half and moved apart in a longitudinal axial direction and a double-length filter rod is inserted in-between.

The tobacco rod sections on the conveying drum are moved apart by subjecting them to a predetermined movement, so that the tobacco rod sections are spaced apart in the longitudinal axial direction. Sliding drums are furthermore known where filter rods, arranged offset to each other in parallel rows, are pushed together to form a single row of sequentially arranged filter rods.

With known spreader drums and sliding drums, the articles on these conveying drums are subjected to a predetermined displacement movement in a longitudinal axial direction. This movement and/or the longitudinal axial displacement on the conveying drum is fixedly preset.

German Patent Document DE-A-41 34 663, for example, describes a device for the axial displacement of a cigarette row, relative to a parallel cigarette row that is passing through. The receiving troughs for the cigarette row to be displaced are arranged at the ends of crank arms, which are bent at right angles, and are positioned in a parallel disc drive. The axes of the parallel disc drive are inclined relative to the axes of a drum conveying a row of cigarettes passing through.

### SUMMARY OF THE INVENTION

In view of the art discussed above, it is an object of the present invention to provide a conveying drum, which subjects articles to be conveyed in the tobacco-processing industry to a low amount of mechanical stress during a longitudinal axial displacement movement, while allowing the continued use of other existing components of a machine in the tobacco-processing industry.

This object is achieved with a conveying drum for moving articles in the tobacco-processing industry that includes a body member that rotates about an axis, and displacement means, mounted on the body member, for moving articles that are aligned in a longitudinal axial direction relative to each other and are supplied cross-axially in at least one row to the conveying drum, wherein the displacement means includes an electric drive.

One embodiment of the invention includes the longitudinal axial displacement of articles on the conveying drum, where electric drives are used for staggering or moving apart such items as cigarettes, tobacco rod sections, or filters in an axial direction. In contrast to mechanical displacement devices for conveyed smoking articles, which generally include a control element, a cam roller and a push rod for the displacement element (e.g. a sliding carriage), the electric drive of one embodiment of the invention directly displaces the displacement element on the conveying device. As a result, the rods which previously required a drive for the mechanical guidance of the sliding carriages and/or the displacement members are now mounted fixedly in the drum and function exclusively as guide rods. In addition, the invention has the advantage of avoiding the problem of contamination with oil, resulting from the lubricating of the control cam and/or the cam roller.

Furthermore, the electric drive noticeably reduces the noise associated with the conveyor drum. In addition, it is no longer necessary to manually replace the control cam of the mechanical displacement element with another control cam during a format changeover. Such a replacement of control elements and/or control cams is costly with down time, element expense and man hours. The displacement movement of elements and/or the electric drive of an exemplary embodiment of the invention is realized with a simple adaptation to an electric drive and by electronically adjusting the control and adjustment device. The control and adjustment device preferably is a software oriented control device. In this embodiment, the electric drive may be provided with a electronic control device.

According to a preferred modification of the invention, the electric drive be embodied as a linear drive or a plunging coil drive. Linear drives and/or linear motors using electromagnets and rotary motors execute continuous linear movements with high precision. Direct linear drives do not comprise mechanical motion converters (e.g., control cams) so that the operation of a linear motor is low-noise and causes little wear. In addition, linear drives have a long service life and are furthermore distinguished by low moving masses, as well as low elasticity and friction. In addition, the motion transfer occurs nearly without play. As a result of these characteristics, linear motors are suitable for use in conveying drums of the tobacco-processing industry since linear drives have a high dynamic and positioning accuracy for executing displacement movements.

The displacement movement executed by the electric drive according to a preferred embodiment of the invention is controllable or regulated in dependence on the position, especially the angular position, of the drive and/or the articles on the conveying drum. The electric drive is preferably provided with a position sensor.

According to another advantageous embodiment of the invention, a position control or regulating device is provided for the electric drive.

To provide the electric drive with energy, the energy is advantageously coupled in via slip rings or in a non-contacting manner.

In addition, one electric drive is advantageously provided for several articles on a sliding carriage.

The conveying drum is preferably embodied as a sliding drum or a spreader drum.

The object is furthermore achieved according to the invention by using an electric drive in a conveying drum for articles in the tobacco-processing industry where the electric drive functions as the displacement means, as described above.

The object of the invention is furthermore achieved with a machine in the tobacco-processing industry, comprising at least one conveying drum with an electric drive as described in the above. This conveying drum is suitable for use in cigarette makers or filter makers, for example, since these machines preferably use spreader drums and/or sliding drums.

### BRIEF DESCRIPTION OF THE DRAWINGS

The invention is explained in the following discussion of exemplary embodiments illustrated in the drawings without a view to restricting the general inventive idea wherein we refer expressly to the drawings for all inventive details not further described in the text. The enclosed schematic drawings illustrate the invention as follows:

FIG. 1 is a partial, cross-sectional view of a conveying drum according to an embodiment of the invention with different drives; and

FIG. 2 is cross-sectional view through a different conveying drum according to the invention.

### DETAILED DESCRIPTION OF THE EMBODIMENTS OF THE INVENTION

Identical or similar elements and/or parts are provided with the same reference numbers. Accordingly, each reference numeral is described once in the following description.

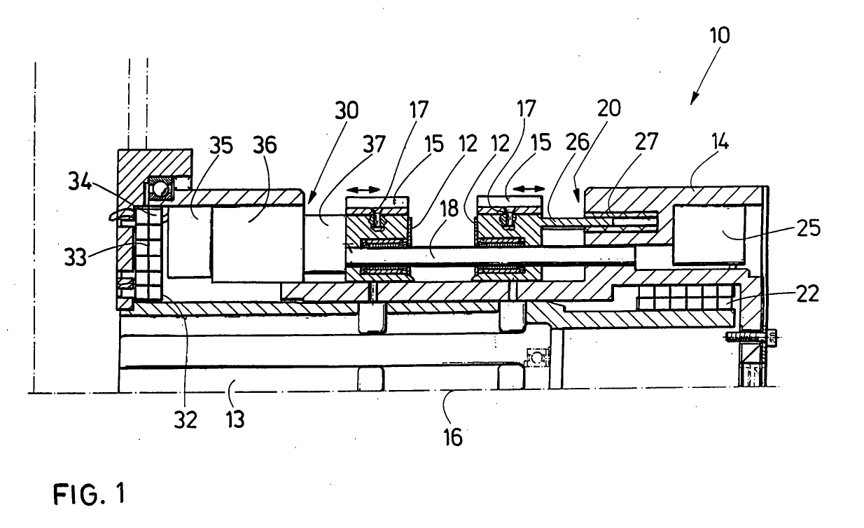

FIG. 1 shows a detail of a cross section through a conveying drum 10 with two different drives 20, 30 for respectively sliding a carriage 12, on which cigarettes 15 are placed, in a respective longitudinal axial direction. The conveying drum 10 comprises a drum body 14 which rotates around a locally fixed shaft 13 with a rotational axis 16. The sliding carriages 12 are provided with receiving troughs, preferably for receiving several cigarettes 15. The cigarettes 15 are held inside these receiving troughs in the sliding carriages 12 by means of a vacuum, generated inside the conveying drum 10 and administered through the vacuum bores 17.

To execute the displacement movements, the sliding carriages 12 are positioned on a rigid guide rod 18, such that they can be displaced. The right side of FIG. 1 shows the displacement movement of a sliding carriage 12 that is realized with a plunger-coil drive 20. The carriage functions to displace articles in the tobacco-processing industry, e.g. cigarettes 15, in longitudinal axial direction while they are being conveyed on the rotating conveying drum 10. The left side of FIG. 1 shows the displacement of the left sliding carriage 12 with the aid of a linear drive 30 in a longitudinal axial direction during the conveying operation. The drum body 14 comprises further a position sensor 19 in order to determine the rotational position of the drum body 14, respectively the angular position of the drum body 14. The conveying operation occurs during the rotation of the drum body 14 around the rotational axis 16, wherein a linear servo system is used as linear drive.

Since the electric drives 20, 30 rotate along with the drum body 14 during the conveying of the articles, the respective drives 20, 30 should be supplied with energy to realize the displacement movements and/or the longitudinal axial movements of the sliding carriages 12. A non-contacting energy-coupling device 32 is shown on the left side of the drawing, which functions to input energy into the linear drive 30 in a non-contacting manner, from a fixed part 33 into a rotating part 34. The company EAAT GmbH in Chemnitz, Germany, for example, is known to produce such a non-contacting energy coupler.

In addition, a control device 35 is provided on the conveying drum 10 for the linear drive 30. The position sensor 19 sends data of the angular position of the drum body 14 to the control device 35. The control device 35 determines the amount of energy required to move linear drive 30 from the position data detected for the sliding carriage 12 respectively from the angular position of the drum body 14 of the conveying drum 10, so that the sliding carriage 12 is displaced an appropriate distance in a longitudinal axial direction. The energy is input through a non-contacting energy input.

The linear drive 30 is composed of two parts: the stator 36 and the rotor 37, wherein the rotor 37 in this case consists of one or several magnets. The stator contains windings as well as the bearing arrangement for the rotor 37.

The linear drive 30 with control device 35 makes it possible to electronically preset a movement curve for the individual sliding carriages 12, in dependence on the angular position of the conveying drum 10, respectively the drum body 14. A format-dependent movement of the sliding carriage 12 can be easily adjusted through a simple change, for example to parameters in a software control, so that a replacement of mechanical parts on the conveying drum 10 is not necessary. By fine-tuning and adjusting the movement parameters in the control, the longitudinal-axial movements of the sliding carriages 12 can be executed individually and independent of each other and can additionally be adapted easily to accommodate different formats during a format change.

The plunging coil drive 20, shown on the right side of FIG. 1, is also provided with a control device 25 which is supplied with energy via a slip ring arrangement 22. With the plunging coil drive 20, one coil part 26 is arranged movable and frictionless in a fixed magnet part 27, for example by means of a sliding bearing arrangement, wherein the coil part 26 is connected to the sliding carriages 12 to be displaced.

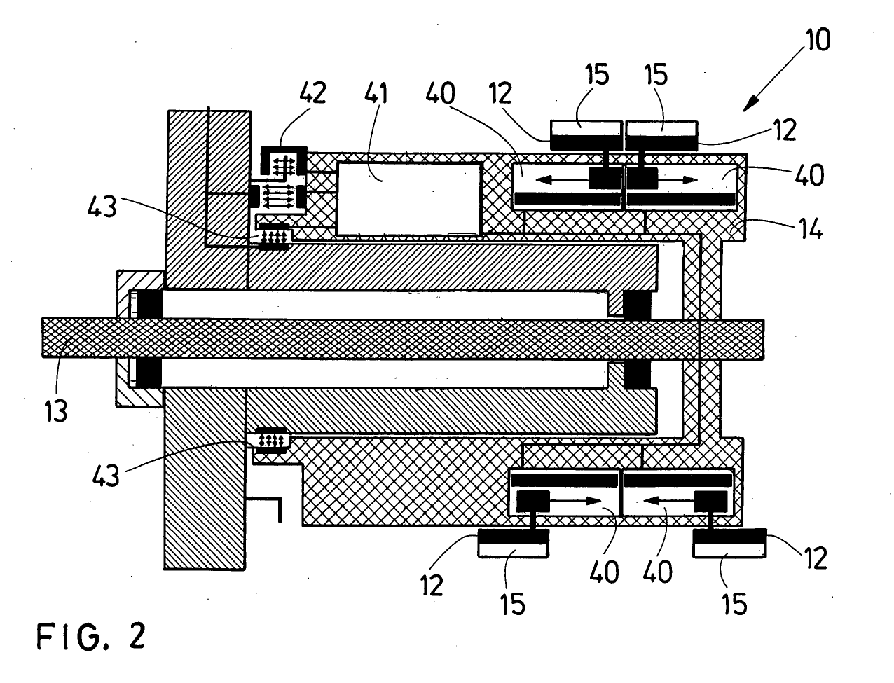

FIG. 2 shows a cross section through an additional conveying drum 10 where the sliding carriages 12 for the cigarettes 15 are moved in longitudinal axial direction by means of an electronic control 41 for linear drives 40. The electronic control 41 has a memory for storing the position in which the respective linear drives 40 for the sliding carriages 12 should be positioned during the rotational movement, or the position to which they should be moved (if the sliding carriages are not there). The linear drives 40, which move the sliding carriages 12 and/or the receptacles and/or the receiving troughs to a corresponding position, can be magnetic drives, for example, or can be based on the piezoelectric principle.

The position of sliding carriages 12 can be detected, for example, with an incremental transmitter, so that the position of the sliding carriages 12 is computed by electronic control 41 in the conveying drum 10. During the process, the data for the positions to be obtained by the sliding carriages 12 are transmitted only once to electronic control 41 in dependence on the angular positions on the conveying drum 10. In the situation where a format change occurs, the changed data positions are transmitted to electronic control 41. The movement control data can be transmitted by means of a non-contacting data transmission device 42 as schematically shown in FIG. 2. In a preferred embodiment, the non-contacting data transmission device 42 may transmit movement control data when the conveying drum 10 is stopped. A non-contacting energy coupler 43 provides the energy for the electronic control 41 and linear drives 40.

The data transmitted for the respective angular positions of the linear drives 40 and/or the sliding carriages 12 are stored in the form of curve data in the memory of the electronic control 41. The electronic control 41, which is integrated into the conveying drum 10, determines the position of conveying drum 10 with the aid of an incremental transmitter or any other position transmitter. Thus, electronic control 41 computes the position to which linear drives 40 should be adjusted with the aid of the curve data stored in the memory, so that the electronic control 41 correspondingly actuates the individual linear drives 40 for the sliding carriages 12 to move an appropriate distance.

With the aid of the subject matter of this invention, the movements of the sliding carriage 12 on the expanding and/or sliding drum can be in any direction.

Direct electric drives have the advantage that the linear displacement movement of the sliding carriages and/or the receiving troughs for articles in the tobacco-processing industry can be carried out without intermittent mechanical gears or parts, variable and without experiencing wear, but with high precision.

1. A conveying drum for moving articles in the tobacco-processing industry, comprising:
a body member that rotates about an axis; and
displacement means, mounted on the body member, for moving articles that are aligned in a longitudinal axial direction relative to each other and are supplied cross-axially in at least one row to the conveying drum, wherein the displacement means includes an electric drive.

2. The conveying drum according to claim 1, wherein the electric drive has a control device.

3. The conveying drum according to claim 2, wherein the control device is an electronic control.

4. The conveying drum according to claim 2, wherein the electric drive is a linear drive.

5. The conveying drum according to claim 2, wherein the electric drive is a plunging coil drive.

6. The conveying drum according to claim 2, wherein the displacement movement of the electric drive is controllable or regulated in dependence on the position of the electric drive and/or the articles on the conveying drum.

7. The conveying drum according to claim 6, wherein the displacement means includes individual sliding carriages upon which the articles are held, the individual sliding carriages being movable in a linear direction while rotating with the body member, and the control device is capable of electronically presetting a movement curve for the individual sliding carriages in dependence on an angular position of the electric drive and/or the articles on the conveying drum to regulate the displacement movement of the electric drive.

8. The conveying drum according to claim 6, wherein the displacement means includes individual sliding carriages upon which the articles are held, the individual sliding carriages being movable in a linear direction while rotating with the body member, and further comprising a position sensor to detect the position of the sliding carriages and/or the articles on the conveying drum.

9. The conveying drum according to claim 8, further comprising a position regulating drive or a position control device for the electric drive wherein the position sensor transmits data to the position regulating drive or position control device to adjust the position of the electric drive and/or the articles on the conveying drum.

10. The conveying drum according to claim 1, further comprising slip rings wherein energy is coupled into the electric drive via the slip rings.

11. The conveying drum according to claim 1, further comprising a non-contacting energy coupler wherein energy is coupled into the electric drive in a non-contacting manner.

12. The conveying drum according to claim 1, wherein the displacement means includes a sliding carriage and one electric drive moves several articles on the sliding carriage.

13. The conveying drum according to claim 1, wherein the conveying drum is a sliding drum or spreader drum.

14. The use of an electric drive on a conveying drum for moving articles in the tobacco-processing industry, comprising:
displacement means for moving articles that are aligned in a longitudinal axial direction relative to each other and are supplied cross-axially in at least one row to the conveying drum, wherein the displacement means includes the electric drive.

15. A machine in the tobacco-processing industry, comprising at least one conveying drum for moving articles in the tobacco-processing industry, said at least one conveying drum including:
displacement means for moving articles that are aligned in a longitudinal axial direction relative to each other and are supplied cross-axially in at least one row to the conveying drum, wherein the displacement means includes an electric drive.
